(19) United States
(12) Patent Application Publication
(10) Pub. No.: US 2020/0362992 A1
(43) Pub. Date: Nov. 19, 2020

(54) FIXED STANDOFF FOR INSTALLATION OF PIPE INSULATION

(71) Applicant: Michael S. Flynn, Oxford, CT (US)

(72) Inventor: Michael S. Flynn, Oxford, CT (US)

(21) Appl. No.: 16/411,727

(22) Filed: May 14, 2019

(51) Int. Cl. F16L 3/02; F16L 59/14

(52) U.S. Cl. CPC F16L 3/02; F16L 59/14

(57) ABSTRACT

A device for providing a temporary space between and a pipe and a pipe support comprises a standoff having a top and a bottom surface, a depression defined in the top surface, wherein the depression has a shape that corresponds to a diameter of the pipe. The standoff defines a standoff height between at least a portion of the depression and the bottom surface such that in a first condition in which the standoff is disposed between the pipe and the pipe support the standoff defines a space. Insulation is disposable in the space between the pipe and the pipe support in a second condition in which the standoff is removed from between the pipe and the pipe support. A method is also disclosed.

### FIELD OF THE INVENTION

The present invention describes a temporary pipe standoff support and, in particular, describes a temporary pipe standoff for use in installing pipe insulation.

### BACKGROUND OF THE INVENTION

During building construction and/or remodeling, various pipes are installed in the building. These pipes can be used for various purposes such as cold water supply, hot water supply, drainage (e.g., wastewater drainage), venting, HVAC, refrigeration lines, etc. Many of these pipes, especially cold water/refrigerated water pipes, require insulation to be installed around the pipes, for example, to prevent the formation of condensation on the pipes.

The typical installation process involves the installation of the pipes, usually done by one contractor/trade that specialized in pipe installation. After the pipes are installed, the pipes are insulated at a later time, typically by a different contractor/trade. The fact that the pipes are installed first can create problems during the post-installation insulation process. One issue is attendant with the pipe supports that are typically installed to support the weight of the pipes. The pipe supports ordinarily hang from the ceiling of the building and include hanger support rods and a horizontal curved member that is in direct contact with the pipe. The horizontal curved member is in direct contact with the pipe to take the load of the pipe and transfer it to the building structure through the hanger support rods.

With the horizontal support member in direct contact with the pipe, there is no room between the pipe and the horizontal support member to provide insulation around the pipe. Accordingly, installing insulation around the pipes is rendered more difficult and time consuming. The process can involve various combinations of trying to lower the horizontal support member, bending the supports and/or shifting the pipe, and/or completely replacing supports with new support that are correctly positioned to accommodate the thickness of the insulation. This can greatly increase the time and difficulty associated with applying insulation to the pipes.

The present invention, as described herein, addresses these and other issues.

### SUMMARY OF THE INVENTION

In accordance with one aspect of the invention, a device for providing a temporary space between and a pipe and a pipe support comprises a standoff having a top and a bottom surface, a depression defined in the top surface, wherein the depression has a shape that corresponds to a diameter of the pipe. The standoff defines a standoff height between at least a portion of the depression and the bottom surface such that in a first condition in which the standoff is disposed between the pipe and the pipe support the standoff defines a space. Insulation is disposable in the space between the pipe and the pipe support in a second condition in which the standoff is removed from between the pipe and the pipe support.

In accordance with further aspects of the invention, the device can further comprise at least one recess defined in the bottom surface of the standoff and at least one magnet can be disposed in the recess.

In accordance with further aspects of the invention, the bottom surface of the standoff can include two recesses and a magnet is seated within each recess. Alternatively or in addition, the standoff can have at least one magnet seated such that the magnet does not extend beyond the bottom surface of the standoff.

In accordance with an additional aspect of the invention, a method for providing a temporary space between and pipe and a pipe support to provide insulation about the pipe is provided. According to the method, steps are taken including at least installing a standoff between the pipe support and the pipe, fixing the pipe support at a position in which the pipe is supported with the standoff disposed between the pipe and the pipe support, removing the standoff from between the pipe and the pipe support after the position of the pipe support is fixed, and applying insulation about the pipe such that at least a portion of the insulation extends between the pipe and the pipe support. The standoff used in this method can have first and second sides, a front and a rear surface, and a depression defined in the top surface, wherein the depression has a shape that corresponds to a diameter of a pipe.

In accordance with the foregoing method and further aspects of the invention, the standoff can further have at least one recess defined in the bottom surface and at least one magnet disposed in the at least one recess.

In accordance with the foregoing method and still further aspects of the invention, the method can include the further step of adjusting the position of the pipe support after installation of the insulation.

These and other features, aspects and details can be appreciated from the accompanying description of certain embodiments of the invention.

### BRIEF DESCRIPTION OF THE DRAWINGS

FIG. 1 shows a temporary standoff in accordance with one embodiment of the present invention disposed between a pipe and a pipe support;

FIG. 2 is an isometric view of the temporary standoff of FIG. 1; and

FIG. 3 is a front view of the temporary standoff of FIG. 1.

### DETAILED DESCRIPTION CERTAIN OF EMBODIMENTS OF THE INVENTION

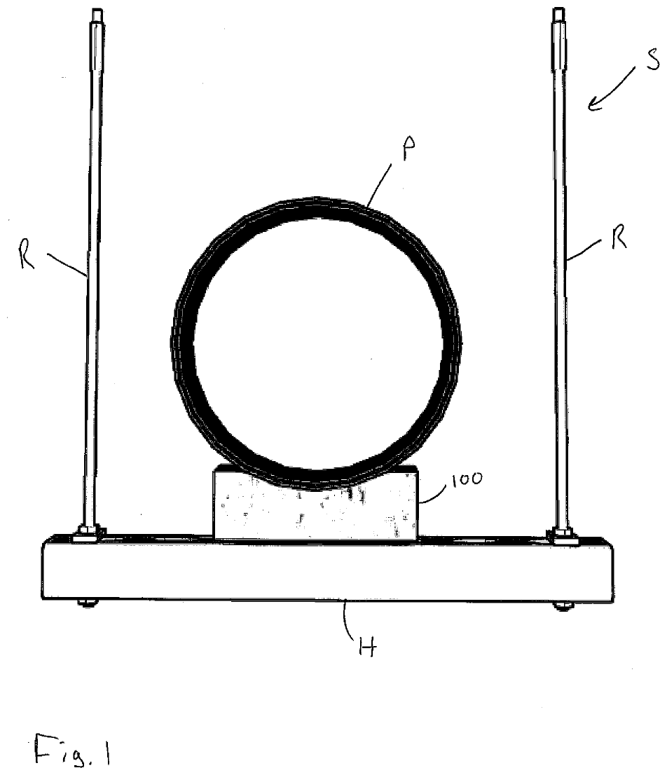

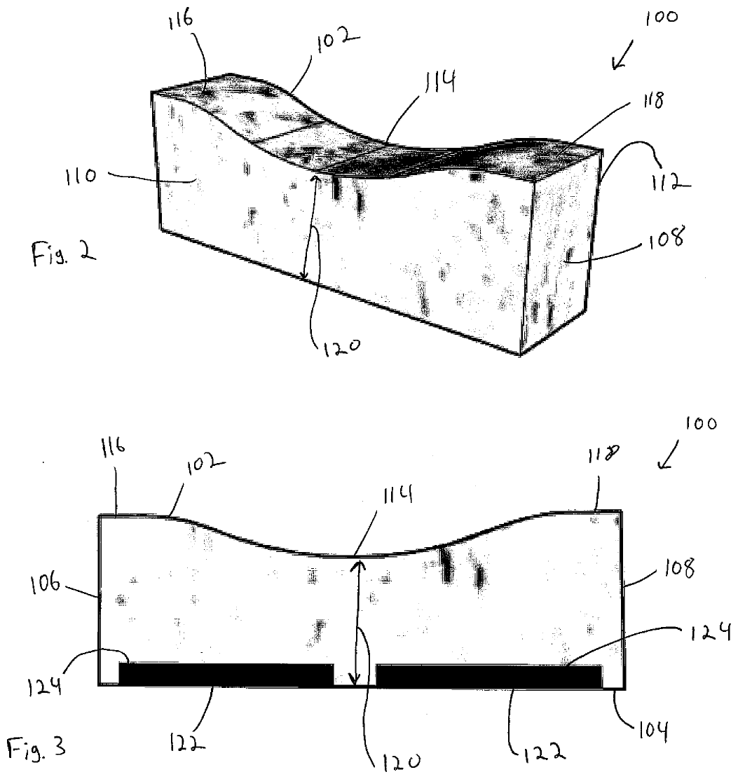

Referring to FIGS. 1-3, a temporary standoff 100 is shown. The temporary standoff 100 can be placed between a pipe P and a pipe support S. The pipe support S includes two horizontal hanger rods R and a horizontal member H. The standoff 100 has a top surface 102, a bottom surface 104, first and second sides 106, 108, a front surface 110, and a rear surface 112.

The tops surface 102 of the standoff 100 includes a depression 114. The depression 114 is generally centrally located between the first and second sides 106, 108 of the standoff 100. The depression 114 can have a curved profile shape. The curved profile shape of the depression can have a radius that approximates the radius of the pipe P. As such, when the pipe P rests on the standoff 100, the pipe P can be seated in the depression 114. When the depression 114 has a shape which corresponds to the shape of the pipe P, the weight of the pipe P can be distributed over a larger surface area (as opposed to a round pipe resting on a flat-shaped surface). The depression 114 can also have a shape designed to accommodate a range of pipe sizes (e.g., 6 to 8 inch pipes). Accordingly, standoffs 100 of different sizes and profiles can be provided to accommodate various pipe sizes, in certain implementations of the invention.

The top surface 102 can also have first and second side areas 116, 118 that extend above the depression 114. With this configuration, the depression 114 and side areas 116, 118 assist in maintaining the pipe P seated within the depression 114 and reduce unwanted movement of the pipe P with respect to the standoff 100.

The distance between the area of the depression 114 and the bottom surface 104 defines a standoff height 120. The standoff 100 can have a standoff height 120 sufficient to accommodate the thickness of insulation that will be applied to the pipe. As one non-limiting example, if the pipe P is to be wrapped with one-inch thick insulation, the standoff 100 have can a standoff height 120 of approximately one inch. As such, when the temporary standoff 100 is removed from between the pipe P and the horizontal member H, there is sufficient space between the pipe P and the horizontal member H to wrap insulation about the pipe. The standoff height 120 can also be made larger or smaller than the insulation thickness. For example, the standoff height 120 can be made slightly larger than the insulation thickness so that the insulation can be installed more easily (after which the pipe support S can be adjusted to contact the insulation and the pipe to support the load of the pipe). The standoff height 120 can be made slightly less than the insulation thickness so that while the insulation may have to be compressed to be installed around the pipe P between the pipe P and the horizontal member H, the pipe support S may be able to better support the load of the pipe P without having to adjust the pipe support S after installation of the insulation. Preferably, the use of the standoff 100 eliminates the need to adjust the pipe support S.

The standoff 100 can also be provided with magnets 122. The magnets 122 can help maintain the standoff 100 on the horizontal member H of the pipe support S during the pipe support installation process and until insulation is installed. One, two, or more magnets 122 can be provided on the underside of the standoff 100. The magnets 122 can be seated within recesses 124 in the bottom surface 104 of the standoff 100. The magnets 122 can be held in place with an adhesive and/or by designing the recesses 124 to captively maintain the magnets 122 once inserted (e.g., by sliding the magnets into a captive slot or by snapping the magnets into suitably formed recesses). Since the horizontal members H of the pipe supports S are typically made from a ferromagnetic material (e.g., steel), the magnets 122 will magnetically hold the standoff in purchase with the pipe support during installation and support processes. The magnets 122 can be sized and specified so that the magnetic force is sufficient to maintain the standoffs 100 attached to the horizontal member H during typical use, but can be removed by a worker at the time when the standoff 100 is to be removed for installation of insulation about the pipe. Alternatively, or in addition, the standoff 100 can be provided with magnets mounted in one or more recesses in the top surface 102 of the standoff (e.g., in the area of the depression 114) so that the standoff can be magnetically mounted to the pipe P (which often are made from ferromagnetic materials).

The standoffs 100 can be supplied as part of a kit, for example. The kit can be job specific in which the number of standoffs provided equals to the number of pipe supports required for the pipe installation job. The standoffs can be preselected based on the diameter of the pipe and thickness of the insulation that will be provided such that the depression substantially corresponds to the diameter of the pipe and the standoff height 120 substantially corresponds to the thickness of the insulation that will be applied to the pipe. As another example, a kit can be provided in which a variety of standoffs are provided which have various combinations of depression profiles and standoff heights. A worker can then select the proper standoff from the kit suitable for the diameter of the pipe and the thickness of the insulation that is to be applied.

The standoffs 100 can be made from various materials such as metal, plastic, wood, or other suitable materials. The standoffs can be made relatively inexpensively, especially if cheap materials such as plastic or wood are used and the magnets are standard, inexpensive magnets. As such, the standoffs can be designed to be single use devices. The standoffs can also be reused for multiple installations, if desired.

As one illustration of an exemplary use of the standoff 100, the pipe P is positioned in place (e.g., within the building under construction) and the support rods R of the pipe support S are attached to the surrounding structure. The horizontal member H is placed underneath the pipe P with the support rods R passing through the horizontal member H. The temporary standoff 100 is disposed between the pipe P and the horizontal member H, which can be magnetically attached to the horizontal member H (or to the pipe P) via magnets 122. The horizontal member H can be raised underneath the pipe P until the pipe P is contacted by the standoff 100 and disposed within the depression 114 (e.g., the standoff can be slidingly moved along the horizontal member H to ensure that the pipe P is properly seated within the depression). Once the horizontal member H is in position such that the pipe is supported by the temporary standoff 100, the horizontal member H can be fixed to the support rods R (e.g., with nuts attached to threaded ends of the support rods). As such, the pipe P is supported and spaced via the temporary standoff 100 until insulation can be installed about the pipe. During the insulation installation process, the temporary standoff 100 is removed from between the pipe P and the horizontal member H and insulation is provided about the pipe P with a portion of the insulation being disposed between the pipe P and the horizontal member H in a space that was previously occupied by the temporary standoff 100. Once the insulation is installed, final adjustments can be made to the pipe support S, if necessary, so that the horizontal member is supporting the weight of the pipe P now that the standoff 100 has been removed and the insulation installed. However, it is preferable that use of the standoff eliminates the need to adjust the pipe support or horizontal member, which significantly improves the efficiency and cost effectiveness of insulation installation.

As can be seen from the forgoing, the present invention provides an improved device and method for installing pipes which require application of insulation. The standoff provides a means for supporting the pipe during the pipe installation process. The magnets allow the temporary attachment of the standoff to a pipe support, which can readily by applied and removed without the need for specialized tools.

Notably, the figures and examples above are not meant to limit the scope of the present application to a single implementation, as other implementations are possible by way of interchange of some or all of the described or illustrated elements. Moreover, where certain elements of the present application can be partially or fully implemented using known components, only those portions of such known components that are necessary for an understanding of the present application are described, and detailed descriptions of other portions of such known components are omitted so as not to obscure the application. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present application encompasses present and future known equivalents to the known components referred to herein by way of illustration.

The foregoing description of the specific implementations will so fully reveal the general nature of the application that others can, by applying knowledge within the skill of the relevant art(s) (including the contents of the documents cited and incorporated by reference herein), readily modify and/or adapt for various applications such specific implementations, without undue experimentation, without departing from the general concept of the present application. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings are shown accordingly to one example and other dimensions can be used without departing from the invention.

While various implementations of the present application have been described above, it should be understood that they have been presented by way of example, and not limitation. It would be apparent to one skilled in the relevant art(s) that various changes in form and detail could be made therein without departing from the spirit and scope of the application. Thus, the present application and invention disclosure should not be limited by any of the above-described example implementations, but rather is defined by the claims that follow and equivalents of the features recited therein.

I claim:

1. A device for providing a temporary space between and a pipe and a pipe support, comprising:
a standoff, the standoff having a top and a bottom surface;
a depression defined in the top surface of the standoff, the depression having a shape that corresponds to a diameter of the pipe; and
wherein standoff defines a standoff height between at least a portion of the depression and the bottom surface such that in a first condition in which the standoff is disposed between the pipe and the pipe support the standoff defines a space,
wherein insulation is disposable in the space between the pipe and the pipe support in a second condition in which the standoff is removed from between the pipe and the pipe support.

2. The device according to claim 1, further comprising at least one recess defined in the bottom surface of the standoff; and at least one magnet disposed in the at least one recess;

3. The device according to claim 2, wherein the bottom surface includes two recesses and a magnet is seated within each recess.

4. The device according to claim 2, wherein the at least one magnet is seated such that the magnet does not extend beyond the bottom surface of the standoff.

5. A method for providing a temporary space between and pipe and a pipe support to provide insulation about the pipe, the method comprising the steps of:
installing a standoff between the pipe support and the pipe, the standoff having:
a. a top and a bottom surface, first and second sides, a front and a rear surface;
b. a depression defined in the top surface of the standoff, the depression having a shape that corresponds to a diameter of a pipe; and
fixing the pipe support at a position in which the pipe is supported with the standoff disposed between the pipe and the pipe support;
removing the standoff from between the pipe and the pipe support after the position of the pipe support is fixed; and
applying insulation about the pipe such that at least a portion of the insulation extends between the pipe and the pipe support.

6. The method according to claim 5, wherein the standoff further has:
a. at least one recess defined in the bottom surface of the standoff; and
b. at least one magnet disposed in the at least one recess.

7. The method of claim 5, further including the step of adjusting the position of the pipe support after installation of the insulation.
